(19) United States
(12) Patent Application Publication
(10) Pub. No.: US 2009/0015659 A1
(43) Pub. Date: Jan. 15, 2009

(54) Method and System for Moderating Multiparty Video/Audio Conference

(76) Inventor: Seungyeob Choi, Los Angeles, CA (US)

Correspondence Address: PARK LAW FIRM, 3255 WILSHIRE BLVD, SUITE 1110, LOS ANGELES, CA, 90010, US

(21) Appl. No.: 11/776,468

(22) Filed: Jul. 11, 2007

(51) Int. Cl. H04N 7/14

(52) U.S. Cl. 348/14.09; 348/E07.084

(57) ABSTRACT

A method and a system are provided for moderating multiparty video/audio conferencing. The method includes the controlled initiation and termination of the video/audio stream from each participant. The method further includes the communication between the moderators and participants and between the multi-point control unit and endpoints. The moderator decides which request among requests from multiple participants should be approved to be broadcast to all participants. Video/audio streams are captured from the approved participant's computer and broadcast to all other participants' computers.

### BACKGROUND OF THE INVENTION

The present invention relates generally to video/audio conferencing and more particularly to managing multi-point video/audio conferences in a controlled manner.

Videoconferencing systems are gaining a growing popularity and have become an efficient medium for business communication and education delivery. A number of different methods have been developed so as to enable two or more parties on distant locations to communicate with one another by transmitting face and voice data between the participants.

One approach to organize the transmission of video and audio data in videoconferencing is to establish a connection for two-way communication (one for sending and the other for receiving) between two parties. Depending on whether the data can be transmitted on both directions at the same time, the communication system is categorized as half-duplex (one direction at one time and the opposite direction at another time) or full-duplex (both directions at the same time).

A number of systems (e.g. conventional messenger-based systems like MSN/Yahoo Messengers or Skype, and some video conferencing systems like SightSpeed, etc.) have been built on this paradigm, and they are particularly well-performing in one-to-one video/audio conversation, and videoconferencing with a limited number of participants (typically up to four).

However, in this approach, when there are more than two parties involved in a conference, a separate connection has to be established between each pair of participants. The number of such two-way connections grows exponentially as the number of participants grows, and when there are a large number of participants in the conference, the bandwidth may easily reach beyond the limit that typical internet users can afford with a DSL or cable-based internet connection from a conventional internet service provider.

In order to have a reasonably large number of participants in a conference, it is necessary to have a centralized unit, called Multi-point Conference Unit (MCU), located in a managed datacenter where a high bandwidth is available. The MCU may be implemented as either hardware or software. A conference participant, called an endpoint, communicates with the MCU only.

Some MCU-based multi-point conferencing systems work in half-duplex mode where only one participant may talk at a given time. The video and audio data are transmitted to other participants in one direction at a time. Some other conferencing systems work in full-duplex mode in a way that any two participants (or a limited number of participants) may communicate with each other but not with the entire participant body at a time.

It may also be possible to transmit all participants' video and audio data to every participant simultaneously throughout the entire conference session, but in that case, the bandwidth problem arises at endpoints and thus the number of participants has to be limited. To resolve this problem, some MCU-based conferencing systems reduce the size of video and audio data. The video data can be reduced by sending post-stamp sized video frames of all participants with low frame rate to all participants. Some systems like WebEx only show a fixed number (e.g. one or four at a time) of video screens regardless of whether the participants in the screens are talking. The audio data size can be reduced by transmitting the audio data in a half-duplex way or by having the MCU capable of combining the multiple audio streams to a single stream. A successful example of such system is Marratech.

However, the existing models of conference control(regardless of whether half- or full-duplex mode) may frustrate participants as this communication model is different from the conventional in-person communications in conference or classroom settings that people are already familiar with. In the general perception about conference or classroom communications, multiple parties may be allowed to talk simultaneously, the faces of all current speakers have to be present at the same time, and the moderator (or the instructor) has to be responsible to control the communications in an organized way. In addition, the speaker's face should not be present on his/her own screen, and in the same way, the voice should not be echoed from his/her own speaker. It makes the entire control and data flow a little more complicated, and makes it impractical to mix the audio streams at the MCU and broadcast the same single audio stream to every endpoint. The problem of providing real-time video/audio communications in an online conference or classroom under a well-organized control is hard to tackle (even if possible) in the control structures employed by existing multi-point conferencing systems.

In a classroom setting, it is not acceptable to allow every participant to have an equal opportunity to talk at any time as they wish. In general, a moderator has to be responsible to initiate and terminate the speech of a participant.

U.S. Pat. No. 5,823,788 “Interactive educational system and method” provides a system that enables a user to interactively communicate with an instructor, but it is totally irrelevant in the context where the video and audio of a user are broadcast also to other users as well as to the instructor.

U.S. Pat. No. 6,823,363 “User-moderated electronic conversation process” provides a user moderation process in the context of text-based chat rooms. The patent describes the process of initiation and control of moderator status and the control of text messages in an electronic conversation. U.S. Pat. No. 7,107,311 “Networked collaborative system” provides a structural system that enables a moderator to post questions and the participant body to be split into separate groups to discuss the question.

A need for an efficient method to control the presence of each participants face and voice in a similar way that is commonly practiced in an in-person conference and classroom environment has been present for a long time.

### SUMMARY OF THE INVENTION

The present invention contrives to solve the disadvantages of the prior art.

The invention includes a method and apparatus to manage a multi-point video/audio conference. The method solves the problems related to the control of the initiation and termination of the speech (video and audio streams) of participants.

In order to be able to talk in a conference, a participant has to express his/her intention by clicking the “raise hand” or similarly named button. On the moderator's point of view, this may be viewed as a request for the initiation of broadcast. The moderator makes a decision whether to approve the request. Once the moderator approves it, the media encoder is initiated on the participant's computer who has clicked the “raise hand” button, and the video and audio data are captured from the input devices and broadcast to other participants. In case where the participant has an input device for either video or audio only, other participants receive video-only or audio-only stream and the media player on each endpoint will handle such stream appropriately.

The method eliminates the interruptions, distractions and disruptions associated with the absence of moderator's control over who should talk at a given time. By keeping the initiation and termination of broadcast under the moderator's control, the method further eliminates the limitations associated with the technical difficulties of broadcasting a participant's face and voice data to a large number of other participants. The main idea is to restrict the transmission of video and audio data of a participant based on the moderator's approval.

Unlike conventional videoconferencing systems where either only one participant may talk at a time or each participant decides whom to talk to, the invention described here has a moderator who decides which participants can talk. Unlike some other videoconferencing systems where post-stamp sized video frames of all participants are simultaneous broadcast or only one participant (or a fixed number of participants) is broadcast to others at a time, the invention described here enables the system to be capable of dynamically increasing and decreasing the number of simultaneous speakers. No matter how many participants join the conference, the amount of data transmitted to each endpoint at a given time is decided by the number of speakers at the time. The method both enables multi-parties to speak simultaneously and at the same time overcomes the scalability problems of a videoconferencing by limiting the number of video and audio streams in a controlled matter.

The invention comprises a centralized MCU and multiple endpoints. Typically, the MCU is located in a managed data center where a large bandwidth is available, and endpoints are located on computers of participants and are connected to the internet. The MCU further comprises a control unit (often called Multipoint Controller and Multipoint Processor) and a set of sockets connected to endpoints. An endpoint further comprises a set of media encoders and decoders (video and audio data use different sets of encoders/decoders), multiple instances of media players (including buffers and synchronizer), a control unit, and a socket connected to the MCU (may be a collection of sockets depending on implementations).

The invention is not intended to fully or partially replace existing signaling processes (such as H.323 or SIP) that have been designed for VoIP and videoconferencing applications. The method and apparatus provided here may be integrated with or be implemented on the basis of those existing signaling framework.

Unlike prior art, the invention does not include any account of how to initiate and control the moderator status, but describes a method to solve the problem of how to initiate and control each participant's speech in the context of multi-point videoconferencing by sending and receiving “raise hand” and “lower hand” messages between the moderators and participants. The invention provides a method that enables participants to “raise hand” to indicate that there is something that the participant want publicly to speak to others and a moderator to make a decision whether to approve the request.

The invention is explained again with regard to the claims. The invention provides a method for moderating multi-party video/audio conference. A plurality of endpoints participate in the conference and the endpoints comprise one or more moderators and more than two users. The method comprises steps of sending request for broadcast initiation by one of the users, deciding to approve the sending request by one of the moderators, capturing video and/or audio data at the user for which the request for broadcast initiation has been approved and broadcasting the captured video and/or audio data to endpoints except the endpoint that sent the request for broadcast initiation.

In the step of sending request, the request for broadcast initiation is sent to an MCU. In the step of capturing, the video and/or audio data are sent to the MCU. In the step of broadcasting, the MCU broadcasts the video and/or audio data.

In the step of sending request, the user sends a RAISE HAND message to the MCU as the request for broadcast initiation. The RAISE HAND message is then forwarded to the moderator. In the step of deciding, when the request is approved, the moderator sends an INIT STREAM message to the MCU. In the step of capturing, the MCU sends the INIT STREAM message to the user that sent the request and the user starts capturing video and/or audio data.

The invention also provides a system for moderating multi-party video/audio conference. The system includes a plurality of endpoints that comprise one or more moderators and more than two users, each of which can send request for broadcast initiation, an MCU to which the endpoints are connected over an internetwork, a session manager that shows all users that are currently logged in the conference and a broadcast queue that shows the user(s) that sent the request for broadcast initiation.

Each of the moderators decides which one of the requests for broadcast initiation with the session manager and the broadcast queue. Video and/or audio data are captured at the user for which the request for broadcast initiation has been approved. The captured video and/or audio data are broadcast to endpoints except the endpoint that sent the request for broadcast initiation. The request for broadcast initiation is relayed by the MCU. The captured video and/or audio data are sent to the MCU, and the MCU broadcasts the video arid/or audio data.

The user sends a RAISE HAND message to the MCU as the request for broadcast initiation and the endpoint that sent the request for broadcast initiation is added to the broadcast queue. The MCU forwards the RAISE HAND message to the moderator. When the request is approved, the moderator sends an INIT STREAM message to the MCU. The MCU forwards the INIT STREAM message to the user that sent the request and the user starts capturing video and/or audio data.

Each of the endpoints comprises an input device for capturing video and/or audio data. When the endpoint receives the INIT STREAM message, the endpoint initiates the input device and the input device captures video and/or audio data and encodes the data.

The endpoint sends a LOWER HAND message to the MCU as request for cancelling broadcast request, and the endpoint that is indicated by the LOWER HAND message is removed from the broadcast queue.

The moderator sends an EXIT STREAM message to the MCU, and the MCU forwards the EXIT STREAM message to the endpoint specified by the moderator. When the endpoint receives the EXIT STREAM message, the endpoint terminates the input device.

When the request for broadcast initiation is approved by the moderator, a new video window is opened on every user's screen except the user that sent the request for broadcast initiation.

Each of the endpoints comprises an output device that delivers the video and/or audio data. When the endpoint receives the video and/or audio data, the output devices decode and deliver the video and/or audio data. When there is more than one video data being broadcast simultaneously, each of the video data is displayed separately. When there is more than one audio data being broadcast simultaneously, the audio data are combined together and the resulting single stream is sent to the output device.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a screen diagram that shows an end point in moderator mode;

FIGS. 2a, 2b and 2c are flow diagrams illustrating control flow at an endpoint;

FIGS. 3a 3b are flow diagrams illustrating control flow at an MCU; and

FIG. 4 is a schematic diagram showing signal flows between endpoints.

### DETAILED DESCRIPTION OF THE INVENTION

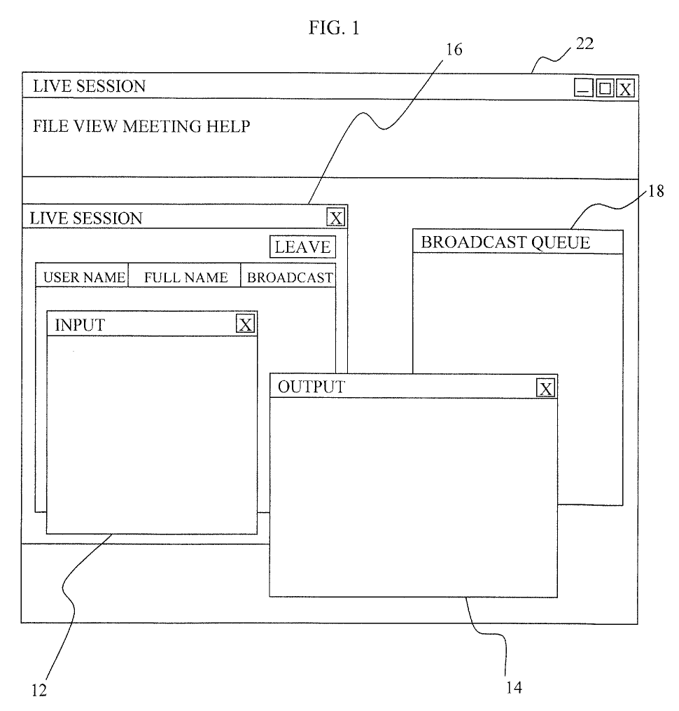

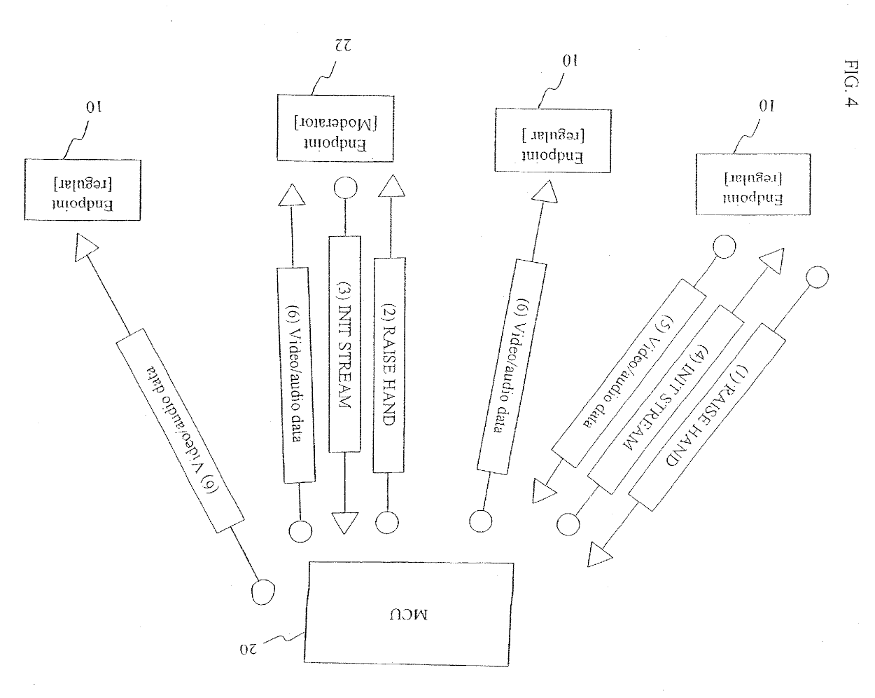

FIG. 1 is a screen diagram of an endpoint 22 (refer to FIG. 4) in a moderator mode. FIG. 1 shows two videos, a first video 12 for input from the video input device of the user that is being broadcast to others, and a second video 14 for broadcasting of video stream from another user).

Behind those two videos are a session manager 16 and a broadcast queue 18. The session manager 16 (located behind the first video 12 in FIG. 1) displays all users who are currently logged in a conference. The broadcast queue 18 (located behind the second video 14 in FIG. 1) is only displayed in the moderator mode, and regular participants do not have it on their screen.

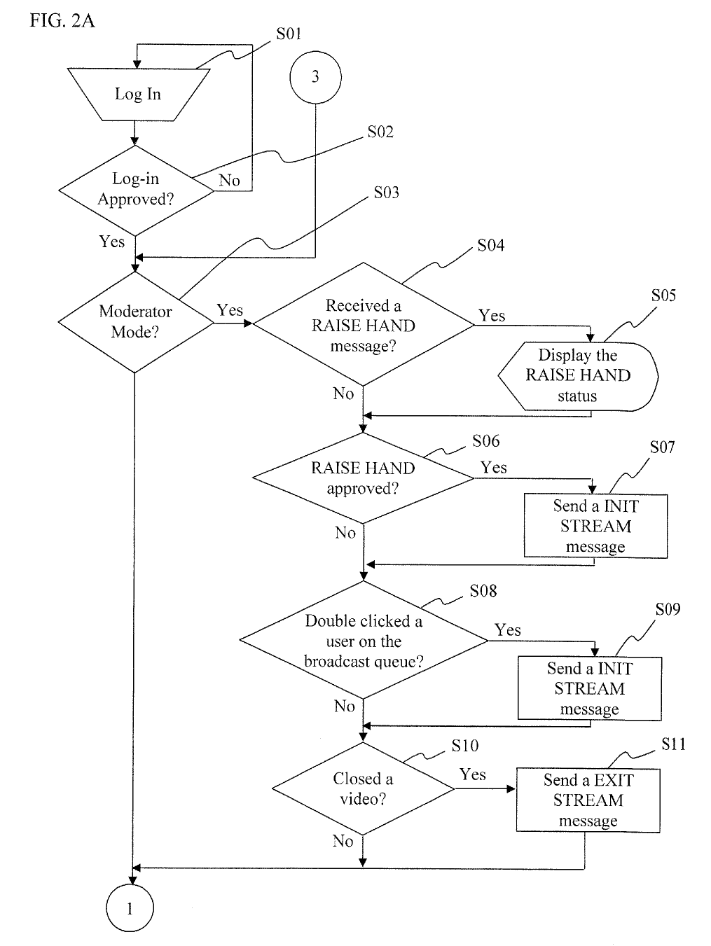

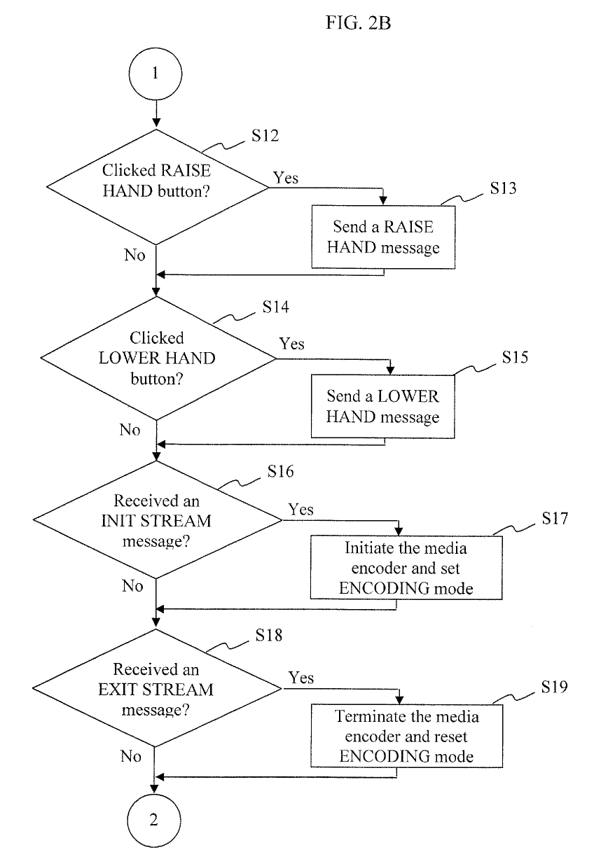

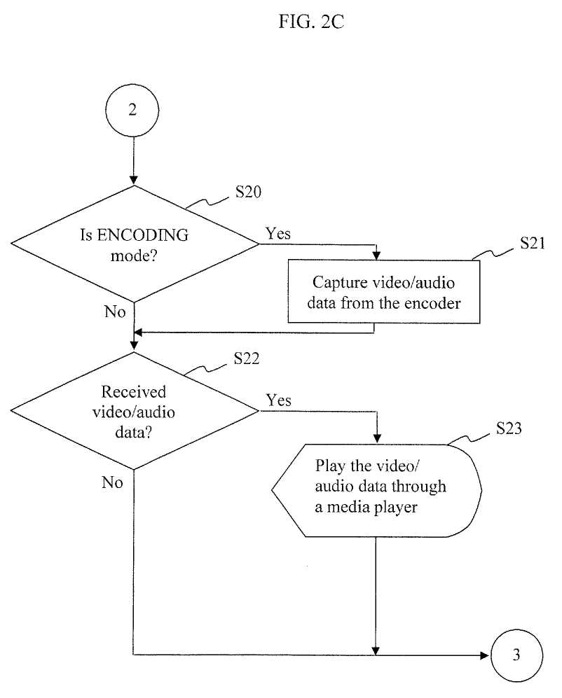

The broadcast queue 18 shows users who raised their hands (in other words, those who expressed their intention to publicly ask or talk something). When a moderator double-clicks one user in the broadcast queue 18, a new video will be opened on every user's screen except the user that is being broadcast to show that user's video. FIGS. 2a-2c illustrate control flow at an endpoint. In step S01, a log-in request with a user ID and password is sent to an MCU 20 (refer to FIG. 4) for joining a conference. In step S02, if the request is approved by the MCU, the endpoint receives a “log-in approved” message along with a mode identifier. The mode identifier is either moderator or regular participant.

In step S03, if the endpoint is determined in the moderator mode, the endpoint may receive RAISE HAND or LOWER HAND messages originally initiated from one of the nodes (endpoints) of the MCU in step S04. When the endpoint receive RAISE HAND message in step S04, the RAISE HAND status is displayed in step S05. When the RAISE HAND request is approved by the moderator in step S06, an INIT STREAM message is sent in step S07.

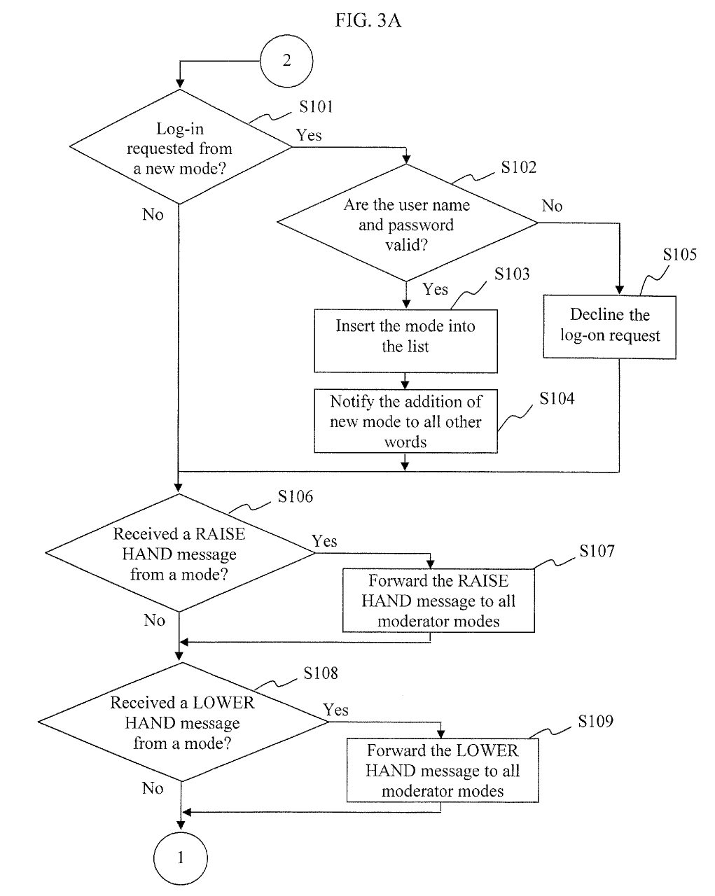

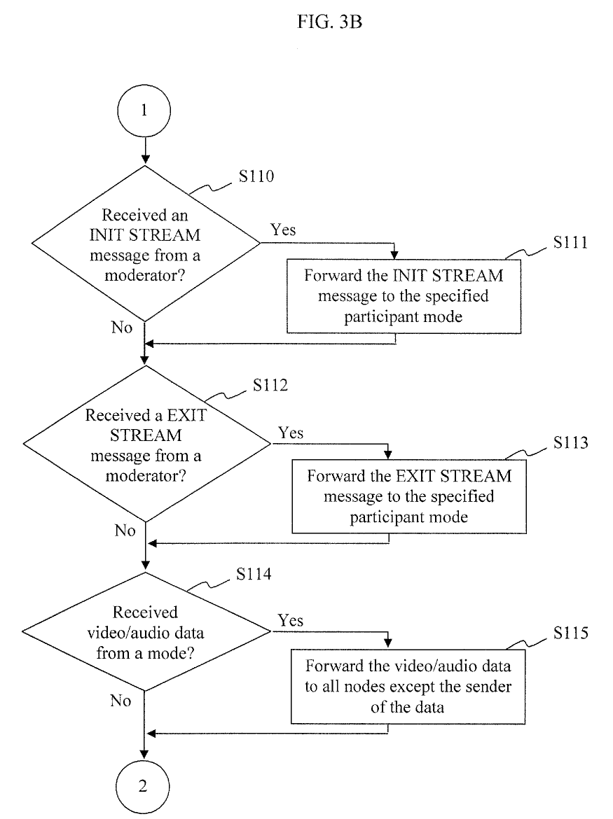

When the RAISE HAND or LOWER HAND messages are received by the moderator endpoint, the node (endpoint) that originally initiated those messages will be added to the broadcast queue on the moderator's screen (in case of RAISE HAND) or removed from the broadcast queue (in case of LOWER HAND) as further explained below referring to FIGS. 3a and 3b.

If the moderator double clicks the node on the broadcast queue 18 (or alternatively on the session manager 16) in step S08, an INIT STREAM message is sent to the MCU by the moderator, and then the MCU forwards the message to the specified node (the node that originally sent the RAISE HAND message) in step S09. When a video is closed in step S10, an EXIT STREAM message is sent in step S11.

If a user (may be either a moderator or a regular participant) clicks “raise hand” button in step S12, a RAISE HAND message is sent to the MCU, and the MCU then forward the message to all moderator nodes in step S13.

If a user (may be either a moderator or a regular participant) clicks “lower hand” button in step S14, a LOWER HAND message Is sent to the MCU, and the MCU then forward the message to all moderator nodes in step S15.

It is possible that more than one moderator is in a conference, and in that case, any moderator can initiate or terminate the video/audio stream from a participant.

If the endpoint receives an INIT STREAM or EXIT STREAM from the MCU in step S20, it initiates (INIT) or terminates (EXIT) input devices that capture video data from the camera and sample audio data from the microphone in step S21. When the input devices are running, the data from the input devices are encoded by codec and sent to the MCU.

If the endpoint receives video/audio data from the MCU in step S22, the data are decoded using codec, sent to the output devices (e.g. screen, headset, speakers, etc.), and played in step S23. When there is more than one video/audio stream being broadcast simultaneously, each video stream is sent to its corresponding video screen, and the audio streams are combined together and the resulting single stream is sent to the audio output device.

FIGS. 3a and 3b illustrate the control at the MCU. The MCU maintains a set of connections to the endpoints (refer to FIG. 4).

When a new log-in request from a node (endpoint) is received in step S101 and the user ID and password are verified in step S102, the node will be added in the list in step S103 and the addition of new node is notified to all other nodes in step S104. If the user ID and password are found invalid in step S102, the log-in request is declined in step S105.

When the MCU receives a RAISE HAND message from a node (either a moderator or regular participant) in step S106, the MCU forwards the message to all moderator nodes in step S107.

When the MCU receives a LOWER HAND message from a node (either a moderator or regular participant) in step S108, the MCU forwards the message to all moderator nodes in step S109.

When the MCU receives an INIT STREAM from a moderator node in step S110, the MCU forwards the message to the specified node (the node that has originally initiated the RAISE HAND message) to initiate the video/audio stream in step S111.

When the MCU receives an EXIT STREAM message from a moderator node in step S112, the MCU forwards the message to the specified node (the node that has originally initiated the RAISE HAND message) to terminate the video/audio stream in step S113.

When the MCU receives video/audio data from a node (either a moderator or regular participant) in step S114, the MCU forwards the data to all nodes except the node that sent the data in step S115 (because the video/audio do not need to be played on the speaker's own screen and speaker).

FIG. 4 illustrates the communications of signals between moderators and regular participants and between the MCU 20 and endpoints 10, 22.

When a user, that is, one of the regular endpoints 10 clicks the “raise hand” button, the RAISE HAND message is sent to the MCU 20. The RAISE HAND message is forwarded to the moderator node 22. The node 10 is displayed on the broadcast queue 18 on the moderator's screen.

When the moderator permits the node to start video/audio stream (by double clicking the node on the screen), the INIT STREAM message is sent to the MCU 20.

The INIT STREAM message is then forwarded to the node 10 that sent the original RAISE HAND message. The receipt of INIT STREAM message indicates that the node can now start sending a video/audio stream. The video/audio input devices are started.

The video/audio data are sent to the MCU 20.

The MCU 20 broadcasts the video/audio data to all nodes 10, 22.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A method for moderating multi-party video/audio conference, wherein a plurality of endpoints participate in the conference and the endpoints comprise one or more moderators and more than two users, the method comprising steps of:
a) sending request for broadcast initiation by one of the users;
b) deciding to approve the sending request by one of the moderators;
c) capturing video and/or audio data at the user for which the request for broadcast initiation has been approved; and
d) broadcasting the captured video and/or audio data to endpoints except the endpoint that sent the request for broadcast initiation.

2. The method of claim 1, wherein in the step of sending request, the request for broadcast initiation is sent to an MCU, wherein in the step of capturing, the video and/or audio data are sent to the MCU, and wherein in the step of broadcasting, the MCU broadcasts the video and/or audio data.

3. The method of claim 2, wherein in the step of sending request, the user sends a RAISE HAND message to the MCU as the request for broadcast initiation, wherein in the step of deciding, when the request is approved, the moderator sends an INIT STREAM message to the MCU, wherein in the step of capturing, the MCU sends the INIT message to the user which sent the request and the user starts capturing video and/or audio data.

4. A system for moderating multi-party video/audio conference comprising:
a) a plurality of endpoints, wherein the endpoints comprise one or more moderators and more than two users, wherein each of the user can send request for broadcast initiation;
b) an MCU to which the endpoints are connected over an internetwork;
c) a session manager that shows all users that are currently logged in the conference; and
d) a broadcast queue that shows the user(s) who sent the request for broadcast initiation;
wherein each of the moderators can decide which one of the requests for broadcast initiation with the session manager and the broadcast queue, wherein video and/or audio data are captured at the user for which the request for broadcast initiation has been approved, wherein the captured video and/or audio data are broadcast to endpoints except the endpoint that sent the request for broadcast initiation, wherein the request for broadcast initiation is relayed by the MCU, wherein the captured video and/or audio data are sent to the MCU, and wherein the MCU broadcasts the video and/or audio data.

5. The system of claim 4, wherein the user sends a RAISE HAND message to the MCU as the request for broadcast initiation and the endpoint that sent the request for broadcast initiation is added to the broadcast queue, wherein the MCU forwards the RAISE HANDE message to the moderator, wherein when the request is approved, the moderator sends an INIT STREAM message to the MCU, wherein the MCU forwards the INIT STREAM message to the user that sent the request and the user starts capturing video and/or audio data.

6. The system of claim 5, wherein each of the endpoints comprises input devices for capturing video and/or audio data, wherein when the endpoint receives the INIT STREAM message, the endpoint initiates the input devices and the input devices capture video and/or audio data and encode the data.

7. The system of claim 4, wherein the endpoint sends a LOWER HAND message to the MCU as request for cancelling broadcast request, and the endpoint that is indicated by the LOWER HAND message is removed from the broadcast queue.

8. The system of claim 4, wherein the moderator sends an EXIT STREAM message to the MCU, wherein the MCU forwards the EXIT STREAM message to the endpoint specified by the moderator.

9. The system of claim 8, wherein each of the endpoints comprises input devices for capturing video and/or audio data, wherein when the endpoint receives the EXIT STREAM message, the endpoint terminates the input devices.

10. The system of claim 4, wherein when the request for broadcast initiation is approved by the moderator, a new video window is opened on every user's screen except the user that sent the request for broadcast initiation.

11. The system of claim 4, wherein each of the endpoints comprises an output device that delivers the video and/or audio data, wherein when the endpoint receives the video and/or audio data, the output devices decode and deliver the video and/or audio data.

12. The system of claim 11, wherein when there is more than one video data being broadcast simultaneously, each of the video data is displayed separately.

13. The system of claim 11, wherein when there is more than one audio data being broadcast simultaneously, the audio data are combined together and the resulting single stream is sent to the output device.
